(19) United States
(12) Patent Application Publication
(10) Pub. No.: US 2024/0059937 A1
(43) Pub. Date: Feb. 22, 2024

(54) ADHESIVE DELIVERY SYSTEM

(71) Applicant: 3M INNOVATIVE PROPERTIES COMPANY, St. Paul, MN (US)

(72) Inventors: Andrew J. Stockholm, Stillwater, MN (US); Ryan J. Eismin, St. Paul, MN (US); Encai Hao, Woodbury, MN (US); David J. McDaniel, Lino Lakes, MN (US); Yongshang Lu, Woodbury, MN (US); Karen J. Calverley, Stillwater, MN (US)

(21) Appl. No.: 17/754,544

(22) PCT Filed: Oct. 9, 2020
(86) PCT No.: PCT/IB2020/059514

§ 371 Date: Apr. 5, 2022

Related U.S. Application Data
(60) Provisional application No. 62/914,157, filed on Oct. 11, 2019.

(51) Int. Cl. C09J 7/40; C09J 7/35; C09J 7/38

(52) U.S. Cl. CPC C09J 7/401; C09J 7/35; C09J 7/405; C09J 7/38; C09J 2467/006

(57) ABSTRACT

The present invention is an adhesive delivery system including a conformable film having top and bottom faces, an adhesive releasably coated on at least a portion of the top face of the conformable film, and a light release liner adhered to the adhesive side opposite the conformable film.

### FIELD OF THE INVENTION

The present invention relates to an adhesive delivery system. In particular, the present invention is a system for delivering an adhesive to a shaped surface.

### BACKGROUND OF THE INVENTION

Die cut or laser cut adhesives are widely used as optical and/or bonding layers in electronic and automotive displays. With the increased trend of displays in both consumer electronics and automotive becoming more complex and taking new shapes, such as being non-flat or curved, various materials and manufacturing methods need to be developed to apply adhesives onto the shaped surface. Adhesives used in electronic displays are generally provided with a release liner on each surface to protect the adhesive until the adhesive is ready for use. The release liners used to apply the adhesive in electronic displays have typically been rigid and dimensionally stable.

To laminate the adhesive to a surface, various methods can be used. In one method, a roller laminator is used to laminate adhesive to 2D and 2.5D (curved on 2 opposite edges) display surfaces. In this method, a light release liner is removed from the adhesive and one edge of the adhesive is aligned with the mating edge of the display layer surface. Aided by the support of a rigid heavy release liner, a roller then applies the adhesive precisely to the display surface. Another method to laminate an adhesive onto a display surface is to use a vacuum laminator. In this method, the adhesive is secured to an applicating surface and aligned above the display layer surface. The adhesive is then applied to the display surface under surface pressure in a vacuum environment.

While rigid liners provide effective support to an adhesive when laminating to 2D and 2.5D surfaces, they can present some issues when laminating an adhesive to 3D surfaces due to potential large deformation required to conform and stress that can buckle the liner material. One solution to the buckling problem is to use a less rigid liner or to reduce the rigidity of the process liner with heat during the lamination process; however, this can create quality problems at each step of the manufacturing process. When a less rigid liner is used, the adhesive and liner are pulled over the display surface in a vacuum and adhered. Traditional liners can wrinkle as parts of the liner are pulled to and over the curved corners of the display surface. While the less rigid liners allow for shaping to a curved surface, they can be limiting in that they must have enough rigidity to support the adhesive during the coating, converting, and assembly processes.

### SUMMARY OF THE INVENTION

In one embodiment, the present invention is an adhesive delivery system including a conformable film having top and bottom faces, an adhesive releasably coated on at least a portion of the top face of the conformable film, and a light release liner adhered to the adhesive side opposite the conformable film.

### BRIEF DESCRIPTION OF THE DRAWINGS

The invention may be further illustrated by reference to the accompanying drawings wherein:

FIG. 1A is a bottom view of a first embodiment of a delivery system according to the present invention.

FIG. 1B is a cross-sectional view of the first embodiment of the delivery system according to the present invention.

FIG. 1C is a cross-sectional view of an alternate to the first embodiment of the delivery system according to the present invention.

FIG. 1D is a cross-sectional view of an alternate to the first embodiment of the delivery system according to the present invention.

FIG. 2 is a bottom view of a second embodiment of a delivery system according to the present invention.

FIG. 3 is a bottom view of a third embodiment of a delivery system according to the present invention.

FIG. 4 is a bottom view of a fourth embodiment of a delivery system according to the present invention.

FIGS. 5A-5H are a flow chart of a first embodiment of a method of manufacturing an adhesive delivery system according to the present invention.

FIGS. 6A-6H are a flow chart of a second embodiment of a method of manufacturing an adhesive delivery system according to the present invention.

FIGS. 7A-7L are a flow chart of a third embodiment of a method of manufacturing an adhesive delivery system according to the present invention.

FIG. 8A-8O are a flow chart of a fourth embodiment of a method of manufacturing an adhesive delivery system according to the present invention.

FIGS. 9A-9C show a flow chart of an adhesive being laminated to a shaped surface according to an embodiment of the present invention.

FIG. 10 is a side view of a setup in which an adhesive is stretched over a puck prior to lamination.

FIG. 11 shows a side view of the setup in which the adhesive is clamped down during the lamination process to stretch the adhesive over the puck.

FIG. 12 is a graph showing displacement as a function of puck hardness.

### DETAILED DESCRIPTION

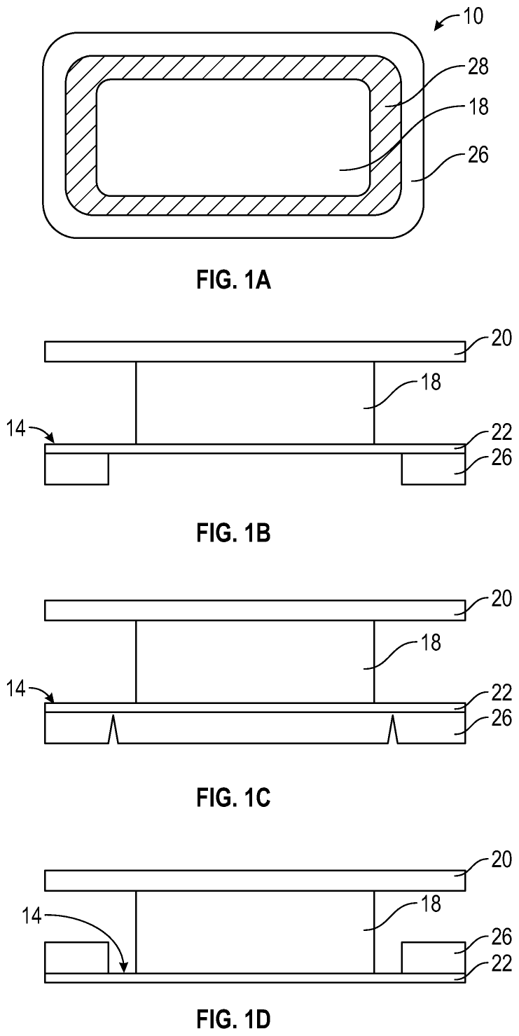

FIG. 1A shows a bottom view and FIGS. 1B, 1C, and 1D show cross-sectional views of an embodiment of an adhesive delivery system of the present invention. The adhesive delivery system enables optical/display bonding of two substrates wherein at least one of the substrates is shaped (e.g., curved or otherwise non-planar, including topography). That is, where at least one of the substrates curves out of plane in both the x and y-axis. The adhesive delivery system generally includes an adhesive on a conformable film (also referred to as a conformable liner, the terms being used interchangeably throughout this specification). The conformable film may be supported by a more rigid frame carrier to help overcome handling and precision problems associated with a conformable film. The rigid frame carrier supports lamination of adhesive to shaped surfaces without liner stress buckling and resultant adhesive lamination defects. Furthermore, in one embodiment, the present invention provides a method and apparatus in which portions of the rigid frame carrier that are not desired during use are optionally removed prior to use by the consumer, thereby minimizing the steps necessary to apply the adhesive and reducing the waste stream at the consumer level. FIG. 1B shows the waste removed, while FIG. 1C shows the waste not removed.

The adhesive delivery system of the present invention is particularly useful in the field of electronic display manufacturing. For a planar film to conform uniformly to a three-dimensional curved surface, the film will bend, stretch and/or compress as it contacts the mating surface, which can create stress both in the film and surface substrate. The deformation strain of the film can generate stresses that exceed its yield strength where if the stress is then released, the deformation strain does not fully recover, which is defined as plastic deformation. If the strain is recovered, then the material is typically considered elastic or viscoelastic where the strain recovers with time. Materials such as polyurethane will recover strain significantly better than polypropylene films, for example, when strain levels exceed about 10%. If strain deformation is held fixed, the stress level can relax. If a stress is maintained, the material can also generate creep strain, where the material continues to deform with time. Creep can occur at any given strain level when stress is present. In one embodiment, the conformable film is conformable to three-dimensional (3D) electronic display layer surfaces. As such, when the adhesive is applied to a display layer surface using the conformable film, the adhesive conforms to the surface uniformly, without wrinkles or optical distortion.

The adhesive delivery system 10 of the present invention, as shown in the figures, includes a heavy release liner 12 having a top face 14 with release properties and a bottom face 16, an adhesive 18 coated on at least a portion of the top face 14 of the heavy release liner 12, and a light release liner 20 releasably adhered to the adhesive 18 opposite the heavy release liner 12. The heavy release liner 12 is a two-layer peelable construction and includes a conformable film 22 and a rigid liner 24 which may also be employed as a rigid frame carrier 26 for the conformable film 22. The rigid frame carrier 26 is attached to and covers at least a portion of the conformable film 22. The rigid frame carrier 26 is formed of material substantially more rigid than the conformable film 22 to provide rigidity to the delivery system 10, particularly after removal of the light release liner 20. The rigid frame carrier 26 may be permanently or releasably attached to the conformable film 22. In the embodiments shown in FIGS. 1A, 1B, 1C, and 1D, the rigid frame carrier 26 does not extend into the adhesive area, allowing the adhesive 18 to have maximum ability to conform to a surface.

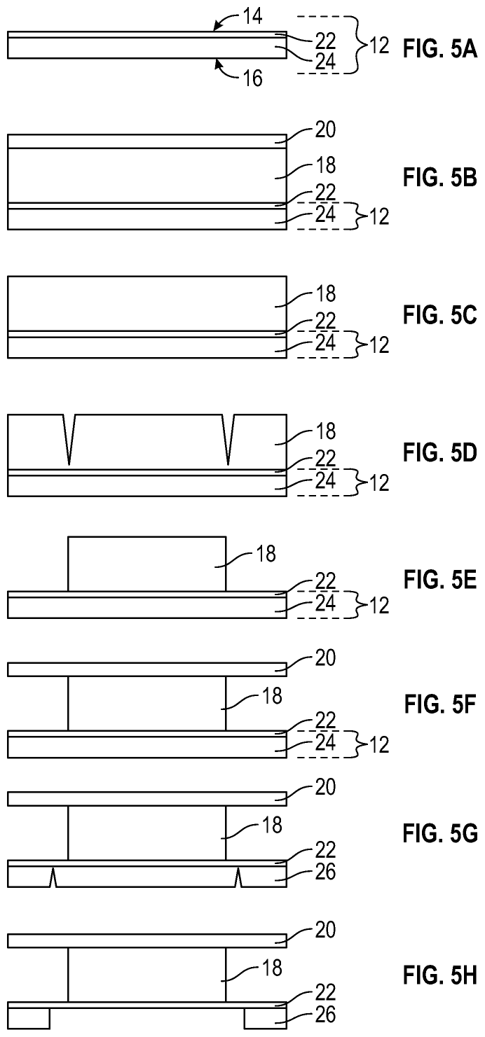

In one embodiment, the heavy release liner 12 includes a thin, stretchable, conformable film 22 having a surface treated with a release coating and a rigid frame carrier 26. In one embodiment, the release coating can include, but is not limited to: silicone, fluoropolymer, or hydrophobic alkyl acrylate. Where the rigid liner 24 supporting the conformable film 22 is also the rigid frame carrier 26 (as shown in FIG. 5), the bond between the rigid frame carrier 26 and conformable film 22 is less than the bond between the adhesive 18 and both the heavy release 12 and light release liners 20. The bond between the rigid frame carrier 26 and conformable film 22 is similar to or equal to, but not greater than, the bond between the adhesive 18 and the light release liner 20. Where the rigid frame carrier 26 is different than the rigid liner 24, the rigid liner 24 may be removed and the rigid frame carrier 26 is bonded to the thin conformable film 22 during the converting process to support the adhesive part during optical/display surface lamination. In one embodiment, the rigid frame carrier 26 can extend beyond the size and shape of the adhesive 18 to provide support and approximation of the adhesive 18 above the shaped surface before the lamination is done under vacuum. In one embodiment, the heavy release liner 12 may also include at least one frame tab. The frame tab can be used to remove the thin conformable film 22 from the adhesive after application.

In one embodiment, the rigid frame carrier 26 includes a window 28 around the adhesive 18 so that the entirety of the conformable film 22 contacting the adhesive 18 is free to conform to the surface unencumbered during the lamination process. In another embodiment, the present invention also offers the advantage of strategically locating the rigid frame carrier 26 on the conformable film 22 behind certain areas of the adhesive 18 to control strain of the conformable film 22 and adhesive 18 as desired. By controlling strain, optical defects can be reduced.

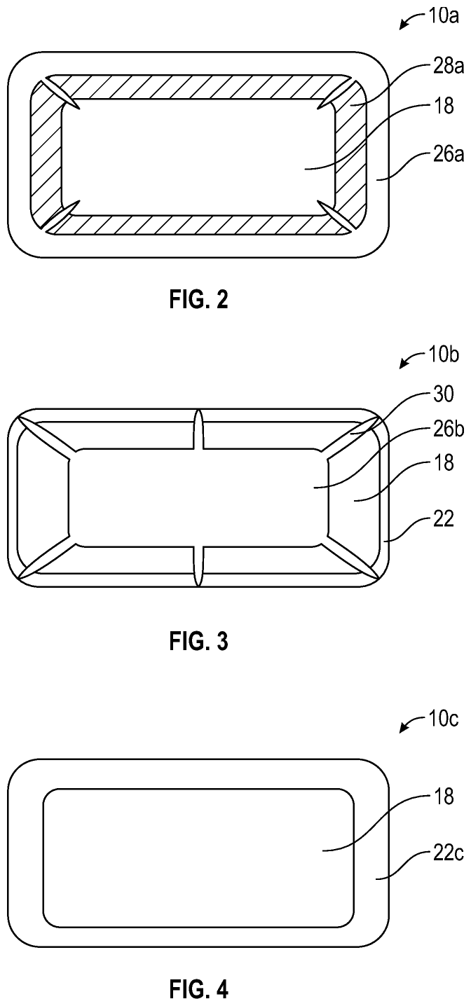

FIGS. 2 and 3 show bottom views of second and third embodiments 10a and 10b, respectively, of the adhesive delivery systems according to the present invention. Each of the second and third embodiments of the adhesive delivery system include varying embodiments of the rigid frame carrier 26a, 26b. In certain cases, some control of the adhesive 18 is desired so that it is not free to deform along with the conformable film 22. In these cases, the rigid frame carrier 26 may extend into the adhesive area to reduce and/or control the amount of stretching in desired areas, such as the corners. In the second embodiment 10a shown in FIG. 2, the rigid frame carrier 26a includes a window 28a proximate the center of the adhesive 18 and an external frame 26a proximate a perimeter of the adhesive 18 to provide support to the adhesive 18. In the third embodiment 10b shown in FIG. 3, an internal frame 26b is used in an area of the adhesive 18 that does not require a lot of conformability. In this embodiment, the rigid frame carrier 26b is proximate the center of the adhesive 18 and includes projections 30 extending out toward the edges of the adhesive 18 to maintain the shape of the adhesive 18.

FIG. 4 further shows a bottom view of a fourth embodiment 10c of an adhesive delivery system of the present invention. In the fourth embodiment 10c shown in FIG. 4, the adhesive delivery system does not include a rigid frame carrier. In this case, the conformable film 22c is rigid enough to provide structure to the adhesive delivery system or is fully laminated by a removable, rigid carrier.

The adhesive delivery system 10 of the present invention is useful in connection with any conformable film 22 having an adhesive coating 18 on it. In one embodiment, the adhesive 18 may have a heavy bond to the conformable film 22 and a light bond to another optical film, such as an OLED display, such that the conformable film 22 may be adhered to the OLED to aid in a 3D shaping or laminating process where the adhesive/conformable film substrate is subsequently removed.

Light release liners 20 which are suitable for use in the adhesive delivery system 10 of the present invention can be made of materials including, but not limited to: polyester, polyethylene, polyurethane, polypropylene or composites of such. In one embodiment, the light release liner is coated with release agents such as fluorochemicals or silicones. For example, U.S. Pat. No. 4,472,480, which is hereby incorporated by reference, describes low surface energy perfluorochemical liners. In one embodiment, the light release liner 20 can include, but is not limited to: polyester films and polyolefin films coated with silicone release materials. Examples of commercially available silicone coated release liners include, but are not limited to: RFO2N liner, commercially available from SKC Haas, Korea; LN75 liner, commercially available from Nan Ya Plastics Corp., Taiwan, and those sold by Loparex, located in Cary, North Carolina.

The conformable film 22 of the present invention has a true stress/strain slope that does not exceed about 60 MPa, particularly does not exceed about 40 MPa, and more particularly does not exceed about 20 MPa, from 0 to 100% true strain and has no appreciable plastic (or permanent) deformation. This slope is similar to Young's Modulus for elastic materials, which can be defined as E=σ/ε, where E is Young's modulus, σ is the uniaxial engineering stress or uniaxial force per unit fixed area, and E is the uniaxial engineering strain, or proportional deformation (change in length divided by original length. For large deformation cases, engineering strain does not accurately describe the deformation state and true strain is then defined. True strain is the integral of the change in length divided by length integrated from the original part length which simplifies to the natural logarithm of the engineering strain incremented by 1 unit. For small strains (<1%) engineering strain is like true strain. For 3D lamination cases, true strain can exceed about 50%. True stress is defined like engineering stress except the area is no longer fixed. The slope limit is defined for the conformable material as the slope itself may not be constant. Both E and σ have units of pressure, while E is dimensionless. For a given amount of percent true strain on the conformable film, the true stress should not exceed the value limited by the slope (ex. 100% true strain should not exceed about 40 MPa).

The conformable film 22 is formed from materials having the desirable properties of resiliency and transparency for release liners. In one embodiment, the conformable film 22 is translucent or transparent polymeric films. In one embodiment, the conformable film 22 can include, but is not limited to: polyurethane, polyethylene, polypropylene, polyvinyl chloride, polyacrylate, and combinations thereof.

In one embodiment, the conformable film 22 of the present invention includes a low adhesion coating or surface on the adhesive contact side. The low adhesion coating may be applied by applying a release coating or by adding release additives in the conformable film resin prior to it being casted or extruded as a thin film. In one embodiment, the low adhesion coating on the adhesive facing side is compatible both with the adhesive and the rigid frame carrier bonding method. The low adhesion coating, if present, on the side opposite the adhesive is compatible with the rigid frame carrier bonding method.

The primary considerations in choosing any low adhesion coatings or treatments according to the present invention are their release characteristics and their compatibility with the bond between the rigid frame carrier 26 and the conformable film 22 and between the adhesive 18 and the conformable film 22.

The rigid frame carrier 26 suitable for use in the adhesive delivery systems 10 of the present invention can be made materials including, but not limited to: polyurethane, polyester, polyethylene, polypropylene, or composites of such. In one embodiment, the rigid frame carrier is coated with release agents such as fluorochemicals or silicones. For example, U.S. Pat. No. 4,472,480, which is hereby incorporated by reference, describes low surface energy perfluorochemical liners. In one embodiment, the rigid frame carrier 26 is coated with low adhesion adhesive layer. In such way, the frame carrier can be bonded to the flexible, conformable liner to provide the support of handling during coating, lamination process. In one embodiment, the rigid frame carrier can include, but is not limited to: polyurethane films, polyolefin films, and even paper. Examples of commercially available silicone coated release liners include, but are not limited to: RFO2N liner, commercially available from SKC Haas, Korea; LN75 liner, commercially available from Nan Ya Plastics Corp., Taiwan, and those sold by Loparex, located in Cary, North Carolina.

In one embodiment, the material used to supply the rigid frame carrier 26 for the delivery system 10 is substantially more rigid than the conformable film 22 to prevent the conformable film 22 from wrinkling and controlling undesirable strain of the adhesive 18 during application. The material used for the rigid frame carrier 26 may have a controlled bond to the conformable film 22. In one embodiment, the rigid frame carrier material 26 may be adhesive coated to create a bond to the conformable film 22. In another embodiment, the rigid frame carrier material 26 may also be bonded to the conformable film 22 by extruding the conformable film resin onto the rigid frame carrier material. In yet another embodiment, the rigid frame carrier material 26 may also be heat-sealable to the conformable film, with or without the low adhesion coating, for the purpose of manufacturing the adhesive delivery system 10. In general, materials for the rigid frame carrier 26 can include, but are not limited to: polyester films, polycarbonate films, poly(methyl)methacrylate films, acrylonitrile butadiene styrene films, polypropylene films, polyurethane films, polyethylene terephthalate films, polyoxymethylene films, and combinations thereof.

Other combinations of release liners and adhesives are contemplated for use with embodiments according to the present invention. Those skilled in the art will be familiar with the processes of testing a new adhesive against different liners or a new liner against different adhesives to arrive at the combination of qualities desired in a final product. The considerations pertinent to the selection of a silicone release liner can be found in Chapter 18 of the Handbook of Pressure Sensitive Adhesive Technology, Van Nostrand-Reinhold, 1982, pp. 384-403. U.S. Pat. No. 4,472,480 also describes considerations pertinent to the selection of a perfluoropolyether release liner.

Release liners are available from a variety of manufacturers in a wide variety of proprietary formulations. Those skilled in the art will normally test those release liners in simulated use conditions against an adhesive of choice to arrive at a product with the desired release characteristics.

In one embodiment, the adhesive 18 is an optically clear transfer adhesive having high flow/creep at elevated temperatures of about 65° C., low initial tack at room temperature, and sufficient adhesive properties for the display electronics and automotive industries. As used herein, the term “optically clear” refers to a material that has a haze of less than about 6%, particularly less than about 4% and more particularly less than about 2%; a luminous transmission of greater than about 88%, particularly greater than about 89%, and more particularly greater than about 90%; and an optical clarity of greater than about 98%, particularly greater than about 99%, and more particularly greater than about 99.5% when cured. Typically, the clarity, haze, and transmission are measured on a construction in which the adhesive is held between two optical films, such as poly(ethylene terephthalate) (PET). The measurement is then taken on the entire construction, including the adhesive and the substrates. Both the haze and the luminous transmission can be determined using, for example, ASTM-D 1003-92. The optical measurements of transmission, haze, and optical clarity can be made using, for example, a BYK Gardner haze-gard plus 4725 instrument (Geretsried, Germany). The BYK instrument uses an illuminant “C” source and measures all the light over that spectral range to calculate a transmission value. Haze is the percentage of transmitted light that deviates from the incident beam by more than 2.5°. Optical clarity is evaluated at angles of less than 2.5°. Typically, the PCOCA is visually free of bubbles.

The adhesive 18 can achieve high flow/creep at elevated temperatures of about 65° C., low initial tack at room temperature, and sufficient adhesive properties for the display electronics and automotive industries. The adhesive 18 may be activated to achieve the properties described above in any manner known to those of skill in the art. In one embodiment, the adhesive 18 is a pressure sensitive adhesive (PSA). The PSA may have lower tack, stronger molecular interaction (such as, hydrogen bonding), and high modulus at room temperature. In one embodiment, the adhesive 18 is a heat activated adhesive. In one embodiment, the adhesive 18 acts like a film (e.g. plastic sheet) when laminated and through an ultraviolet dosage, the film turns viscoelastic and into a pressure sensitive adhesive. In one embodiment, the adhesive 18 is a chemical activated adhesive that includes an additive that reacts with the adhesive, very slowly building adhesion as the reaction takes place. In one embodiment, the adhesive 18 can include a silicone that is at the surface of the adhesive 18. The presence of silicone would make the initial adhesion low, thus allowing the adhesive to be reworkable (i.e., peeled off) if there are lamination defects. Over time, the silicone will migrate into the bulk of the adhesive and therefore become tacky to the glass, and build higher adhesion to the glass. In one embodiment, the adhesive 18 may be a tacky pressure sensitive layer but with embodied structures to achieve repositionability and slip properties. In one embodiment, the adhesive 18 may be a tacky pressure sensitive adhesive, but with non-tacky domains to help slip or repositionability. The non-tacky domains may have similar refractive indices with the adhesive layer. The non-tacky domains may be a heat active adhesive formulation.

In one embodiment, the laminating temperature of the adhesive 18 is between about 40° C. to about 150° C., particularly between about 40° C. and about 100° C., more particularly between about 50° C. and about 80° C., and most particularly about 65° C.

Creep is a measurement of how much the adhesive 18 will deform when a given pressure or stress is applied. It would be expected that the higher the creep strain percentage, the more likely the adhesive will “flow” into a 3D shape when laminating pressure is applied. In one embodiment, the adhesive 18 has a creep strain percentage at about 25° C. of between about 0 and about 100%, particularly between about 2 and about 75%, and more particularly between about 2 and about 50%. In one embodiment, the adhesive 18 has a creep strain percentage at about 65° C. of between about 65 and about 800%, particularly between about 85 and about 600%, and more particularly between about 100 and about 500%.

In one embodiment, the adhesive 18 has a glass transition temperature (Tg) of between about −20° C. and about 150° C., particularly between about −15° C. and about 100° C., and more particularly between about −5° C. and about 85° C.

The storage modulus is a measure of the elastic nature of the adhesive 18. The higher the value, the more film like and the higher tendency for the adhesive to have low tack, which can be better for slipping. In one embodiment, the adhesive 18 has a storage modulus at about 25° C. of between about 1E+4 and about 1E+9 Pa, particularly between about 1E+5 t and o about 1E+8 Pa, and more particularly between about 5E+5 and about 5E+7 Pa. In one embodiment, the adhesive 18 has a storage modulus at about 65° C. of between about 1E+2 and about 1E+6 Pa, particularly between about 1E+3 and about 1E+6 Pa, and more particularly between about 1E+4 and about 1E+6 Pa.

The loss modulus is the measure of the viscosity properties of the adhesive 18. The higher the loss modulus, the more the adhesive behaves as a liquid. In one embodiment, the adhesive 18 has a loss modulus at about 25° C. of between about 1E+3 and about 1E+9 Pa, particularly between about 1E+4 and about 1E+8 Pa, and more particularly between about 1E+5 and about 5E+7 Pa. In one embodiment, the adhesive 18 has a storage modulus at about 65° C. of between about 1E+3 and about 5E+6 Pa, particularly between about 1E+4 and about 1E+6 Pa, and more particularly between about 1E+4 and about 1E+5 Pa.

The tan delta of the adhesive 18 is the loss modulus divided by the storage modulus. The tan delta can help describe the “flow” of the adhesive. A high tan delta generally means higher flow, along with more “liquid like” properties. In one embodiment, the adhesive has a tan delta at about 25° C. of between about 0.01 and about 2.5, particularly between about 0.1 and 2.2, and more particularly between about 0.4 and 1.5. In one embodiment, the adhesive has a tan delta at about 65° C. of between about 0.1 and about 3, particularly between about 0.25 and 3, and more particularly between about 0.5 and 2.5.

The adhesive 18 of the present invention also has a peel adhesion of at least about 100 g/cm, particularly at least about 500 g/cm and more particularly at least about 1000 g/cm based on ASTM 3330 when cured. If the peel adhesion of the adhesive 18 is too low, the adhesive 18 will fail and may cause an article including it to come apart (i.e., delaminate). An adhesive may fail in a number of ways.

In one embodiment, the adhesive 18 is imparted with a microstructure pattern to prevent wet out on substrates at room temperature. At elevated temperatures, the adhesive will wet out. The microstructure can function to facilitate air bleed during wet out. The microstructure can be imparted onto the adhesive 18 either by coating directly onto a structured backing or transferring after coating to a structured backing. This structured backing will act as the light and heavy release liner of the transfer adhesive. The heavy release liner will be conformable to the shape of the surface to be covered to reduce buckling of the liner and adhesive during lamination.

In one embodiment, the adhesive 18 is a multi-layer composite. The multi-layer construction includes at least two layers of adhesives with different properties. For example, a thin, less tacky adhesive skin layer and a PSA core layer. The less tacky adhesive layer provides the ability to “slip” during the lamination process, and the thick PSA core can provide efficient flow during the lamination process.

The delivery system 10 of the present invention includes a release on both sides of the conformable film 22—release with the adhesive 18 and release with the rigid frame carrier 26. Or, in some embodiments, the rigid frame carrier 26 is applied to the conformable film 22 as part of the die cutting process versus using the rigid liner 24 as the rigid frame carrier substrate 26. In the case of bonding the rigid frame carrier 26 during the converting process, a strong bond will be created and will have a different set of requirements than the bond if the conformable film 22 is extruded onto the rigid frame carrier 26.

Examples of combinations providing suitable carrier bonding are presented in the examples below, but it is contemplated that many other combinations will also satisfy the requirements for the apparatus and method according to the present invention.

As discussed above, the adhesive delivery system 10 includes a conformable film 22 having a controlled release surface on the top face of the conformable film 22 and a controlled release surface on the bottom surface of the conformable film 22, an adhesive 18 adhered to the top surface of the conformable film 22, a rigid frame carrier 26 adhered to either the top or bottom surface of the conformable film 22, and a light liner 20 attached to the exposed surface of adhesive 18. In one embodiment, the rigid frame carrier 26 is attached to the conformable film 22 with an extrusion melt bond or heat seal bond. Optionally, a window portion 28 can be cut out of the rigid frame carrier 26, creating a frame and a window exposing a portion of the face of the conformable film 22. The rigid frame carrier 26 provides rigidity to the conformable film 22 after the light liner 20 is removed from the delivery system 10. As described above, the low adhesion coating between the liner and the adhesive 18 is compatible with the bond between the rigid frame carrier 26 and the conformable film 22. Various methods of manufacturing the adhesive delivery system 10 of the present invention are discussed below.

FIGS. 5A-5H show one embodiment of manufacturing the adhesive delivery system 10 of the present invention. In this embodiment, the conformable film 22 is first fabricated onto the rigid liner 24 which also becomes the rigid frame carrier 26. The adhesive 18 is then coated between a light release liner 20 and the conformable film 22. In one embodiment, the differential release between the light release liner 20 and the heavy release liner 12 of the adhesive 18 is between about 5 and about 10 g/in. In particular, the release force of the heavy release liner 12 is about 1.5 times greater than the release force of the light release liner 20. In one embodiment, the differential release between the conformable film 22 and the rigid liner 24 is between about 10 and about 20 g/in. In one embodiment, the differential between the heavy release liner 12 and the adhesive 18 is between about 15 and about 25 g/in. The light release liner 20 is then removed and the adhesive 18 is cut as desired. Any adhesive waste is stripped. In one method of manufacturing the delivery system 10, the caliper and modulus of the conformable film provide sufficient structure to allow adhesive waste to be stripped from the conformable film 22 without disrupting the somewhat lower bond between the rigid liner 24 and conformable film 22. The light release liner 20 is laminated to the adhesive 18 to form the adhesive delivery system 10. The rigid carrier frame 26 can be cut from the rigid liner 24 as desired with any waste removed. In this embodiment, the bond between the rigid frame carrier 26 and the conformable film 22 is less than the bond between the adhesive 18 and the conformable film 22. This difference ensures that the adhesive 18 remains attached to the conformable film 22 when rigid frame carrier waste is removed from the delivery system 10. In one embodiment, the bond between the adhesive 18 and the conformable film 22 is not so much greater than the bond between the conformable film 22 and the rigid frame carrier 26 so that the bond between the rigid frame carrier 26 and the conformable film 22 is not disrupted when adhesive waste is stripped. In this embodiment, the conformable film 22 is attached to and supported by the rigid liner 24 during part manufacturing.

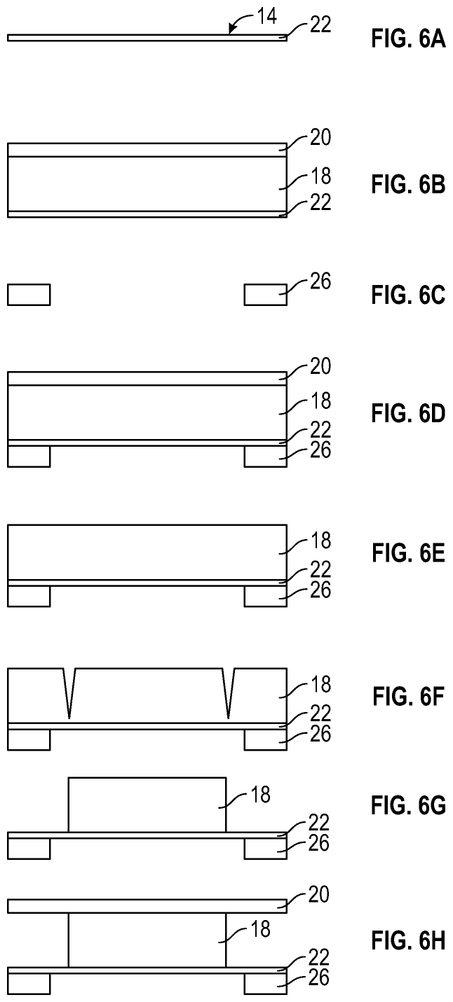

FIGS. 6A-6H show another embodiment of manufacturing the adhesive delivery system 10 of the present invention. In this embodiment, the conformable film 22 is first fabricated. The adhesive 18 is then coated between the conformable film 22 and the light release liner 20. The rigid frame carrier 26 is then laminated to the conformable film 22. The light release liner 20 is removed and the adhesive 18 is cut as desired. Similar to the embodiment shown in FIGS. 5A-5H, the adhesive waste is then stripped and the light release liner 20 is laminated to the adhesive 18 to form the adhesive delivery system 10. In this embodiment, the conformable film 22 is not supported by a rigid material that becomes the rigid frame carrier 26. Rather, the frame is added during manufacturing.

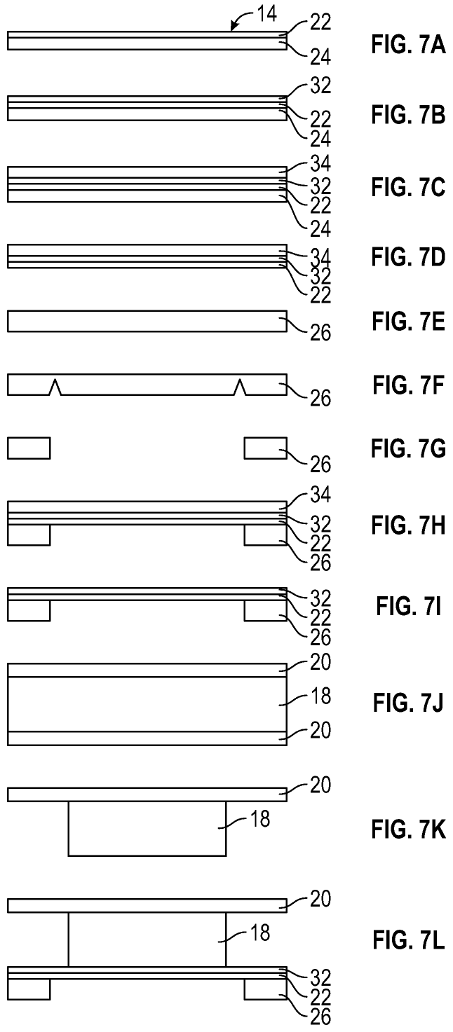

FIGS. 7A-7L show yet another embodiment of manufacturing the adhesive delivery system 10 of the present invention. The embodiment shown in FIGS. 7A-7L is similar to the embodiment shown in FIG. 5 except that a temporary support web 34 is laminated to the release side of the conformable film 22 for support so that the backing of the conformable film 22 that is extruded onto can be removed (rather than becoming part of the rigid frame carrier 26 as in the embodiment of FIGS. 5A-5H), allowing the desired frame material to be laminated in its place. In this embodiment, the conformable film 22 is extruded onto a rigid liner 24 and a release layer 32 is coated onto the conformable film 22. To convert, a temporary carrier 34 is laminated to the release side of the conformable film 22 for support and the rigid liner 24 is stripped from the conformable film 22. The rigid frame carrier material 26 is then die cut as desired and the waste is removed. The rigid frame carrier 26 is then laminated to the conformable film 22. The adhesive 18 is coated between light release liners 20. One release liner 20 is removed from the adhesive 18, the adhesive 18 is die cut, and the waste is stripped. Lastly, the die cut adhesive is laminated to the release side of the conformable film 22.

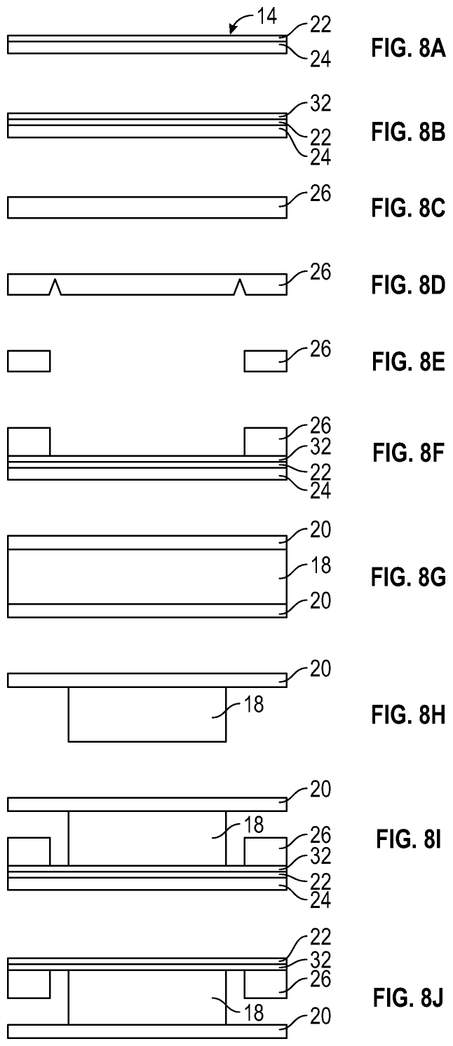

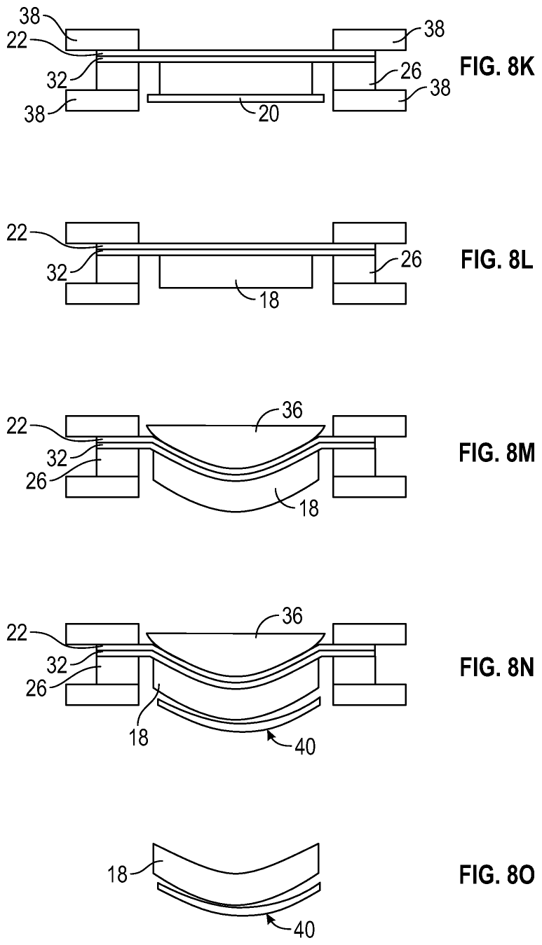

In FIGS. 8A-8O, yet another embodiment of manufacturing the adhesive delivery system 10 of the present invention is disclosed. The embodiment of FIGS. 8A-8O always keeps both the adhesive 18 and the conformable film 22 fully supported by a rigid material until they are laminated together. Furthermore, the rigid materials (light release liner 20 and rigid liner 24) can be easily removed with a low peel force, reducing the risk of deforming or damaging the conformable film/optical film laminate. The first few steps of the embodiment of FIGS. 8A-8O mirror the first few steps of the embodiment of FIGS. 7A-7L. However, the converting step is different. Rather than adhering the carrier frame 26 to the bottom of the conformable film 22, it is adhered to the release side. In this way the rigid liner 24 can remain on the die cut part to support the conformable film 22 until removal is desired. By using the rigid liner 24 for support, a temporary carrier during manufacturing is not required as was the case in FIGS. 7A-7L.

FIGS. 8A-8O go on to show how the adhesive delivery system 10 is fixed in a laminating machine to apply the adhesive 18 onto a shaped surface. The rigid liner 24 is removed and the rigid carrier frame 26 is clamped around the perimeter of the adhesive delivery system 10 with clamps 38. The light release liner 20 is then removed and the adhesive 18 is conformed to a puck 36 which embodies the shape of the 3D part. The adhesive 18 is then laminated to the shaped surface 40, which is in a vacuum to prevent air from trapping between the laminates. Once laminated the parts are released to atmospheric pressures and the puck 36, clamps 38, and conformable film 22 are then removed, with the adhesive 18 adhered to the shaped surface 40.

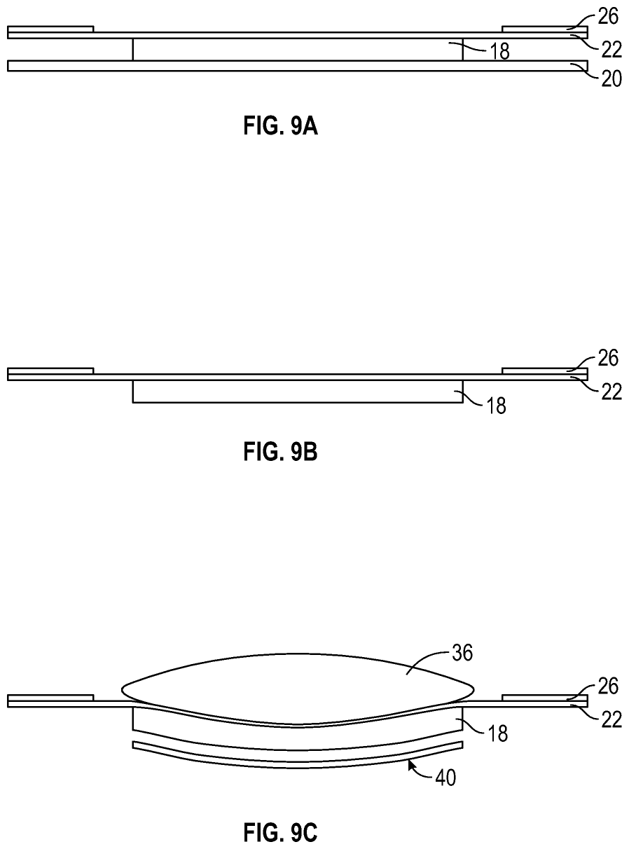

FIGS. 9A-9C show a flow chart of an adhesive 18 being laminated to a shaped surface 40 according to an embodiment of the present invention. This embodiment is similar to the method shown in FIGS. 8A-8O, except that in this embodiment, the frame 26 is assembled on the side of the conformable film 22 opposite the adhesive 18. The adhesive part is first positioned in a laminating fixture and the light release liner 20 is removed. A puck 36 is pressed against the adhesive 18 so that the adhesive 18 takes the shape of the puck 36 when pressed against the shaped surface 40 while in an evacuated chamber.

In practice, the conformable film 22 and the rigid frame carrier 26 are needed to conform the adhesive 18 to the shaped surface 40 and carry with it the adhesive 18 for lamination. In one embodiment, the adhesive 18 and conformable film 22 are pushed onto the surface to be bonded with a puck 36. In cases where the adhesive 18 includes a textured surface, the microstructure on the adhesive 18 facilitates slip for alignment during lamination and air bleed.

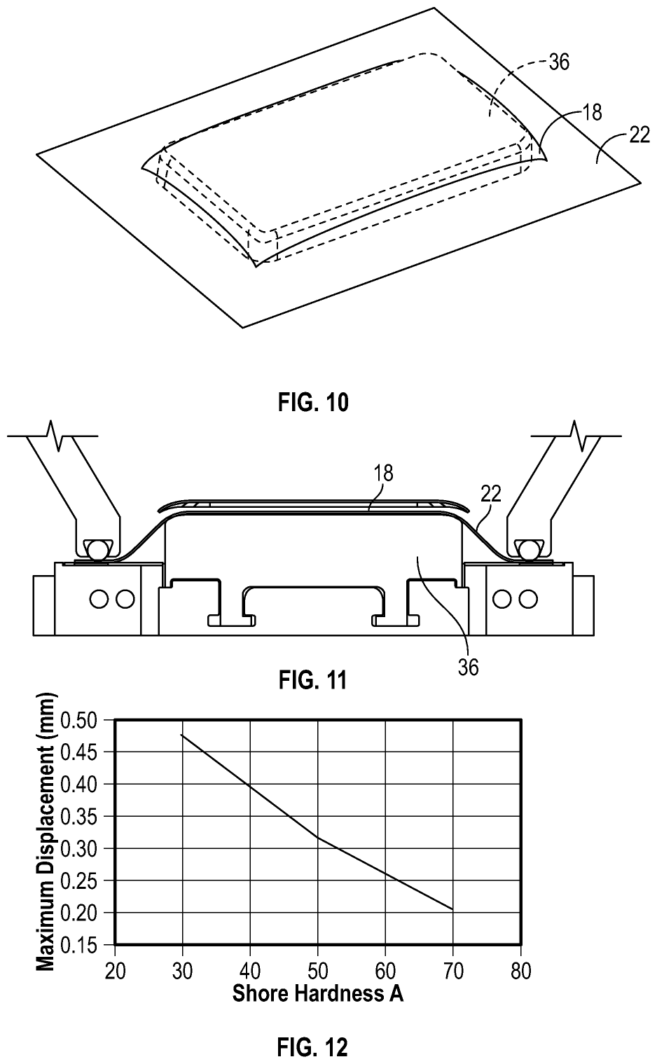

Various methods can be used to optically bond an adhesive 18 of the delivery system 10 to a shaped surface 40. One method uses lamination equipment operating under vacuum to eliminate trapped air. FIGS. 10 and 11 show a top view and a side view, respectively, of an embodiment of a modeling setup for application of the adhesive delivery system 10 of the present invention. In the embodiment shown in FIGS. 10 and 11, an adhesive 18 is stretched over a puck 36 prior to lamination. The equipment contains a clamping mechanism 38 to hold the edges of the adhesive delivery system 10 for conforming to the shape of the surface and a compliant puck 36 to push the adhesive 18 into or onto the shape for improved wet out of the adhesive 18. The adhesive 18 is then clamped down during the lamination process to stretch the adhesive 18 over the puck 36. In practice, the adhesive 18 is held under tension during lamination so that no compression forces are present during the process. Modeling shows that the adhesive 18 must be in tension at all locations during lamination and no compression forces should exist. If compression forces exist, then the adhesive 18 will buckle during lamination, resulting in poor wet out. The adhesive 18 must be constrained on all four sides or buckling will occur on unconstrained side and poor conforming to the puck 36.

In one embodiment, the puck 36 is formed of silicone. Soft silicon pucks will compress during film tension prior to lamination resulting in displacement. This will result in edge contact of the adhesive 18 prior and prevent wet out in corners of the shaped surface 40. As shown in FIG. 12, maximum displacement, which generally occurs at the corners of the puck 36, is a function of puck hardness.

In some embodiments, the resulting laminates can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, glazing (e.g., windows and windshields), screens or displays, cathode ray tubes, and reflectors.

Exemplary optically clear substrates include, but are not limited to: a display panel, such as liquid crystal display, an OLED display, a touch panel or a cathode ray tube, a window or glazing, an optical component such as a reflector, polarizer, diffraction grating, mirror, or cover lens, another film such as a decorative film or another optical film.

Representative examples of optically clear substrates include glass and polymeric substrates including those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes, polypropylenes, and cellulose triacetates. Typically, cover lenses can be made of glass, polymethyl methacrylates, or polycarbonate.

Although the present invention has been described with reference to preferred embodiments, workers skilled in the art will recognize that changes may be made in form and detail without departing from the spirit and scope of the invention.

What is claimed is:

1. An adhesive delivery system comprising:
a conformable film having top and bottom faces;
an adhesive releasably coated on at least a portion of the top face of the conformable film; and
a light liner adhered to the adhesive side opposite the conformable film.

2. The adhesive delivery system of claim 1, further comprising a rigid frame carrier attached to the conformable film.

3. The adhesive delivery system of claim 2, wherein the rigid frame carrier comprises a window.

4. The adhesive delivery system of claim 3, wherein the window of the rigid frame carrier is positioned proximate a center of the adhesive and a rigid frame carrier is positioned proximate a perimeter of the conformable film.

5. The adhesive delivery system of claim 2, wherein the rigid frame carrier is formed of material more rigid than the conformable film.

6. The adhesive delivery system of claim 2, wherein a bond between the rigid frame carrier and the conformable film is such that the adhesive can be removed from the conformable film without disrupting the bond between the conformable liner and the rigid frame carrier.

7. The adhesive delivery system of claim 1, wherein the conformable film is selected from the group consisting of: polyurethane, polyethylene, polypropylene, polyvinyl chloride, polyacrylate, and combinations thereof.

8. The adhesive delivery system of claim 1, wherein the adhesive comprises a multi-layer composite.

9. The adhesive delivery system of claim 1, wherein the adhesive is heat-activated.

10. The adhesive delivery system of claim 1, wherein the adhesive is optically clear.

11. The adhesive delivery system of claim 1, wherein the adhesive comprises microstructures.

12. An adhesive delivery system comprising:
a conformable film having top and bottom faces;
an adhesive coated on at least a portion of the top face of the conformable film;
a liner releasably adhered to the adhesive face opposite the conformable film; and
a carrier strongly or releasably attached to the conformable film, the carrier further being formed of material substantially more rigid than the conformable film.

13. The adhesive delivery system of claim 12, wherein the conformable film is selected from the group consisting of: polyurethane, polyethylene, polypropylene, polyvinyl chloride, polyacrylate, and combinations thereof.

14. The adhesive delivery system of claim 12, wherein the bond between the carrier and the conformable film is stronger than the bond between the adhesive and the conformable film.

15. The adhesive delivery system of claim 12, wherein the adhesive is heat-activated.

16. The adhesive delivery system of claim 12, wherein the adhesive is optically clear.

17. The adhesive delivery system of claim 12, wherein the adhesive comprises microstructures.
